(19) United States
(12) Patent Application Publication
(10) Pub. No.: US 2014/0172325 A1
(43) Pub. Date: Jun. 19, 2014

(54) LIFE MONITORING IN SOLID-STATE DRIVE

(71) Applicant: Ashraf M. Naji, Laguna Niguel, CA (US)

(72) Inventor: Ashraf M. Naji, Laguna Niguel, CA (US)

(73) Assignee: Virtium Technology, Inc., Rancho Santa Margarita, CA (US)

(21) Appl. No.: 13/715,639

(22) Filed: Dec. 14, 2012

(51) Int. Cl. G08B 1/08

(52) U.S. Cl. CPC G08B 1/08
USPC 702/34

(57) ABSTRACT

An embodiment is a method and apparatus for a technique to report remaining life information of a non-volatile memory array. Information on expected life of a non-volatile memory array is received from a solid-state drive (SSD) processor. The information is converted into remaining life information according to a pre-defined format. The remaining life information is transmitted to an indicator or a communication device.

### TECHNICAL FIELD

The presently disclosed embodiments are directed to the field of solid-state drive (SSD), and more specifically, to life monitoring for SSD.

### BACKGROUND

Solid-state drives (SSDs) using flash memory devices (e.g., NAND flash devices) have become increasingly popular in data storage for computer systems, mobile devices, consumer devices (e.g., cameras). In many applications, it is important for users to monitor the life expectancy of the SSDs.

Current techniques for monitoring the life expectancy of the SSDs have a number of drawbacks. Most techniques are mainly developed based on periodic data retrievals from the SSDs. In order for the user to obtain the information, complex circuits or software have to be developed. In addition, in many cases, the interface may not be available for the user to have access to the information in the SSDs.

One disclosed feature of the embodiments is a method and apparatus to report the remaining life information of a solid state drive (SSD). Information on estimated life expectancy of an SSD is received from an SSD processor. The information is converted into remaining life information according to a pre-defined format. The remaining life information is transmitted to an indicator or a communication device.

### BRIEF DESCRIPTION OF THE DRAWINGS

Embodiments may best be understood by referring to the following description and accompanying drawings that are used to illustrate embodiments. In the drawings:

FIG. 1 is a diagram illustrating a system according to one embodiment.

FIG. 2 is a diagram illustrating a status processor according to one embodiment.

FIGS. 3A through 3E illustrate an indicator or communication device according to one embodiment.

FIG. 4 is a flowchart illustrating a process to report the SSD remaining life information according to one embodiment.

### DETAILED DESCRIPTION

One disclosed feature of the embodiments is a technique to report remaining life information of a solid-state drive (SSD) or a non-volatile memory array. Information on expected life of the SSD is received from an SSD processor. The information is converted into the remaining life information according to a pre-defined format. The remaining life information is transmitted to an indicator or a communication device.

The embodiments provide a useful way for the user to determine or monitor the life expectancy of the SSD. For example, the user may quickly Observe the light-emitting diodes or read a message on a liquid crystal display (LCD). The user may also communicate with the SSD subsystem through any appropriate communication protocol such as wireless or wired.

In the following description, numerous specific details are set forth. However, it is understood that embodiments may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

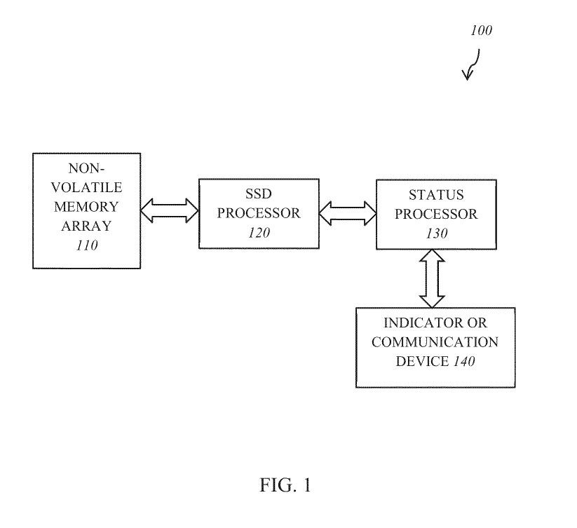

FIG. 1 is a diagram illustrating a system 100 according to one embodiment. The system 100 includes a non-volatile memory array 110, an SSD processor 120, a status processor 130, and an indicator or communication device 140. The system 100 may include more or less than the above components. For example, the status processor 130 may be integrated with the SSD processor 120. In addition, any of these components may be implemented in hardware, software, firmware, or any combination of hardware, software, and firmware.

The non-volatile memory array or SSD 110 may be a storage subsystem having a number of flash devices. Each of the flash devices may be any semiconductor flash memory device such as a NAND flash memory, a NOR flash memory. It may be a single die or a multiple die device. Each of the flash devices in the subsystem 110 may be organized in any configurations, such as 512 Mb to 128 Gb density, block size from 16K to 512K, page size from 512 to 8K, etc.

The SSD processor 120 may be any processor that controls the non-volatile memory array 110. It may be an SSD controller, a host processor, or a processor that is dedicated to estimating the expected life of the non-volatile memory array 110. It may include circuits, modules, or firmware that estimates the expected life of the non-volatile memory array 110. This may be performed by a number of methods. One method is to determine the total number of writes, program or erase cycles, rate of writes (e.g., number of writes per unit time, per day). Another method is to determine the environmental conditions in actual usage such as temperature, humidity, vibration, etc. and correlate these conditions with published manufacturer's data. Another method is to obtain a profile of the flash devices in the SSD using the manufacturer's data. Another method is to combine some or all of the above methods. For example, the number of writes per day may be weighed by the environmental temperature.

The status processor 130 may be any processor that is capable of interfacing to the SSD processor 120 and the indicator or communication device 140. It may include discrete component or drive circuitry to interface to the indicator or communication device 140. As mentioned above, the status processor 130 may be integrated with the SSD processor 120.

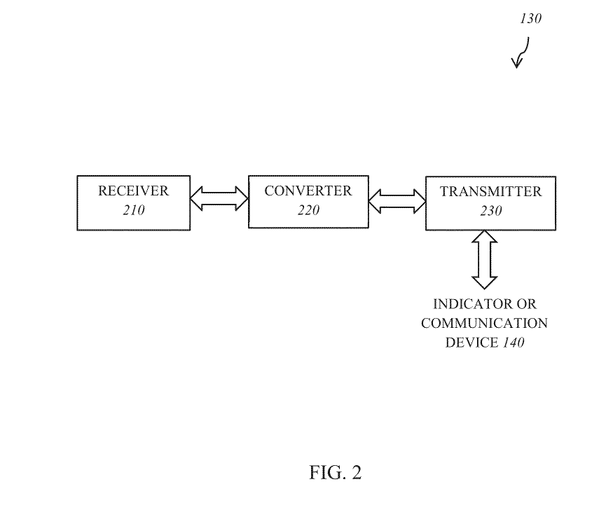

FIG. 2 is a diagram illustrating the status processor 130 according to one embodiment. The status processor 130 may include a receiver 210, a converter 220, and a transmitter 230. The status processor 130 may include more or less than the above components.

The receiver 210 may receive information on expected life of the non-volatile memory array 110 from the SSD processor 120. The information may be received periodically or on demand each time the user wants to know the status on life of the non-volatile memory array 110. The receiver 210 may include a buffer to store the information on the expected life.

The converter 220 may convert the information into the remaining life information or data according to a pre-defined format. The remaining life information or data is the data that reflects the remaining expected life of the non-volatile memory array 110. It may be represented by a percentage, a display message, or a packet of data. The pre-defined format may be compatible with the type of indicator or communication device. For example, if the indicator includes a number of discrete light-emitting diodes, then the format may include a bit pattern that matches with the LED pattern to turn on and turn off the corresponding LEDs to show the expected life. If the communication device is a wireless transceiver, the format may include a packet format with appropriate header information and data.

The transmitter 230 may transmit the remaining life information to the indicator or the communication device 140. The transmission may be compatible with the type of indicator or the communication device 140 and the remaining life information. For example, if the remaining life information indicates the remaining life is short and critical and the indicator 140 includes discrete LEDs, the transmitter 230 may flash the LEDs to alert the user. If the communication device 140 is a wireless transceiver, the transmitter 230 may transmit at a rate compatible with the transmission rate of the wireless device. In addition, the transmitter 230 may have communication interface capability to allow the user to inquire about the remaining life information. For example, the transmitter 230 may send estimated expected life as determined by the SSD processor 120.

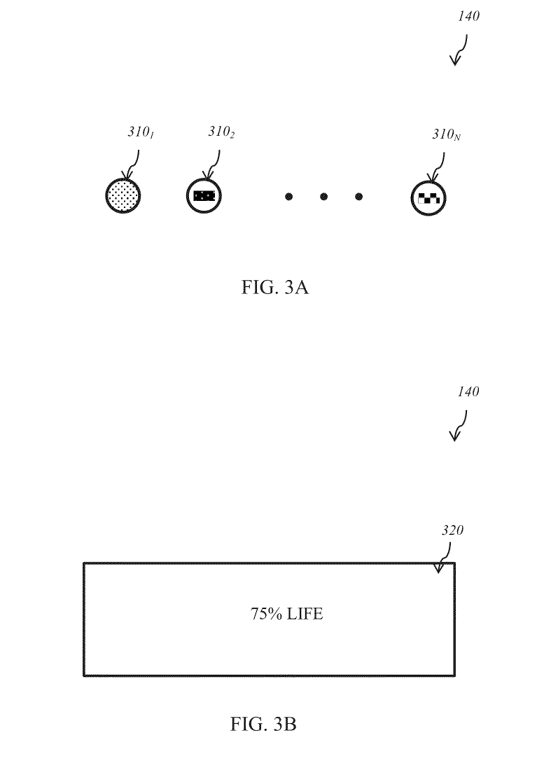

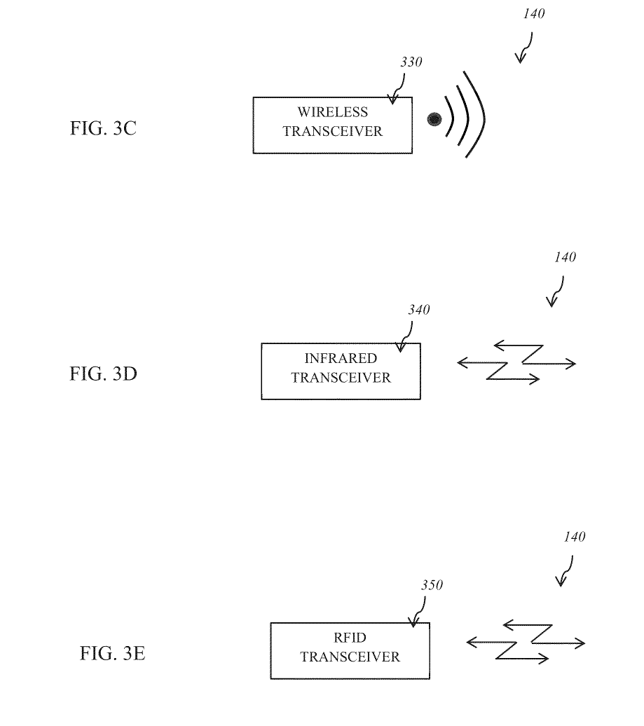

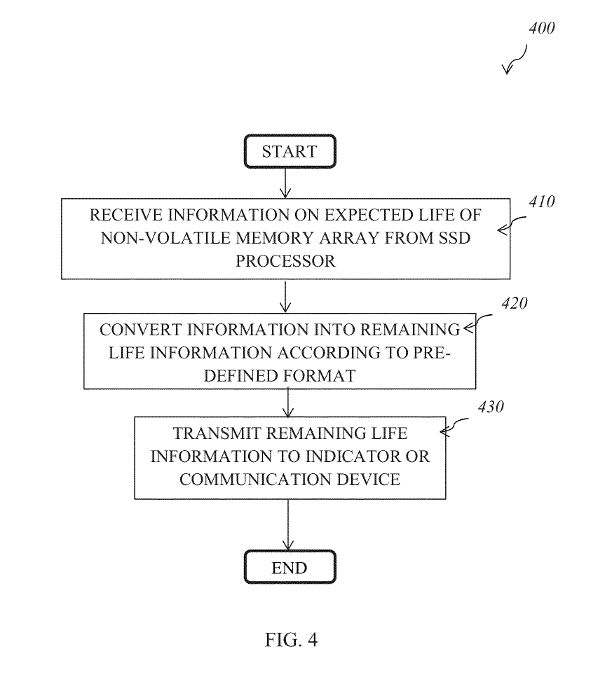

FIGS. 3A through 3E illustrate the indicator or communication device 140 according to one embodiment. The indicator or communication device 140 may be a visual indicator, a wireless or wired communication device.

FIG. 3A shows the indicator 140 as a visual indicator including N LEDs 310₁, . . . , 310_{N} where N is a positive integer. The N LEDs 310₁, . . . , 310_{N} may have different colors. Each of them may be specifically designated with the remaining life information. For example, a red may be used for very low expected life (e.g., 5%); a yellow LED may be used for low to moderate expected life (e.g., 25%); one or more green LEDs may be used for medium or high expected life (e.g., 50%, 75%, or 100%).

FIG. 3B shows the indicator 140 as a visual indicator including a LCD panel 320. The LCD panel may display a message, number, or symbol that represents the remaining expected life. For example, it may display the percentage representing the remaining life (e.g., “75% life”).

FIG. 3C shows the communication device 140 as an 802.11 wireless transceiver 330. FIG. 3D shows the communication device 140 as an infrared transceiver 340. FIG. 3E shows the communication device 140 as a radio-frequency (RF) transceiver 350 such as an REID transceiver. In addition, wired transceiver may also be used such as Universal Serial Bus (USB).

FIG. 4 is a flowchart illustrating a process 400 to report remaining life information according to one embodiment.

Upon START, the process 400 receives information on expected life of a non-volatile memory array such as a solid-state drive (SSD) from an SSD processor (Block 410). The expected life may be estimated based on parameters such as the number of writes on the SSD per day, the environmental temperature, etc. Next, the process 400 converts the information into remaining life information or data according to a pre-defined format (Block 420). The pre-defined format is compatible with the indicator or the communication device. Next, the process 400 transmits the remaining life information to an indicator or a communication device (Block 430). In one embodiment, the indicator may be a visual indicator such as LEDs or LCD and the communication device may be a wireless transceiver, an infrared transceiver, or a radio frequency transceiver (e.g., RFID). The process 400 is then terminated.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to early out the operations described in one embodiment, or code that emulates or simulates the operations. The program or code segments may be stored in a processor or machine accessible medium. The “processor readable or accessible medium” or “machine readable or accessible medium” may include any non-transitory medium that may store information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc, and/or to generate Or pass results, updated variables, pointer, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method comprising:
receiving information on expected life of a non-volatile memory array from a solid-state drive (SSD) processor;
converting the information into remaining life information according to a pre-defined format; and
transmitting the remaining life information to an indicator or a communication device.

2. The method of claim 1 wherein the indicator is a visual indicator.

3. The method of claim 2 wherein the visual indicator is one of a light-emitting diode (LED) display or a liquid crystal display (LCD).

4. The method of claim 2 wherein the communication device is one of a wireless, infrared, or radio frequency (RF) device.

5. An apparatus comprising:
an indicator or a communication device; and
a status processor coupled to the indicator or the communication device to provide remaining life information of a non-volatile memory array to the indicator or the communication device, the status processor comprising:
a receiver to receive information on expected life of the non-volatile memory array from a solid-state drive (SSD) processor,
a converter to convert the information into remaining life information according to a pre-defined format, and
a transmitter to transmit the remaining life information to the indicator or the communication device.

6. The apparatus of claim 5 wherein the indicator is a visual indicator.

7. The apparatus of claim 6 wherein the visual indicator is one of a light-emitting diode (LED) display or a liquid crystal (LCD).

8. The apparatus of claim 5 wherein the communication device is one of a wireless, infrared, or radio frequency (RF) device.

9. A system comprising:
a non-volatile memory array;
a solid-state drive (SSD) processor coupled to the non-volatile memory array to estimate expected life of the non-volatile memory array;
an indicator or a communication device; and
a status processor coupled to the indicator or the communication device to provide remaining life information of the non-volatile memory array to the indicator or the communication device, the status processor comprising:
a receiver to receive information on expected life of the non-volatile memory array from the SSD processor,
a converter to convert the information into remaining life information according to a pre-defined format, and
a transmitter to transmit the remaining life information to the indicator or the communication device.

10. The system of claim 9 wherein the indicator is a visual indicator.

11. The system of claim 10 wherein the visual indicator is one of a light-emitting diode (LED) display or a liquid crystal display (LCD).

12. The system of claim 9 wherein the communication device is one of a wireless, infrared, or radio frequency (RF) device.
